(19) United States
(12) Patent Application Publication
(10) Pub. No.: US 2004/0025026 A1
(43) Pub. Date: Feb. 5, 2004

(54) System-specific passwords

(76) Inventors: Alan H. Karp, Palo Alto, CA (US); Daryl T. Poe, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 10/211,721

(22) Filed: Aug. 2, 2002

(51) Int. Cl. H04L 9/32; H04L 9/00

(52) U.S. Cl. 713/183; 713/181; 713/184; 713/202

(57) ABSTRACT

A method for generating a password that produces a different password for each system from a single password provided by a user. The present techniques enable users to remember one password string from which appropriate system-specific password strings are derived. A system according to the present teachings obtains a user password, generates a combined password by combining the user password with a system name for a system to be accessed, and then generates a system-specific password for the system to be accessed from the combined password using a one-way hash that conforms to a well-defined specification.

### BACKGROUND OF THE INVENTION

1. Field of Invention

The present invention pertains to the field of system access. More particularly, this invention relates to passwords.

2. Art Background

Passwords are commonly employed in system access including access to computer systems and information services. For example, web sites commonly provide a login procedure during which a user enters a password that enables access to a user account. Typically, a user is required to select a password for each system to be accessed.

A user may select a different password for each system to be accessed. If a relatively large number of systems are to be accessed then a user is likely rely on a record of passwords rather than on human memory. Unfortunately, written records of passwords are vulnerable to loss or theft and computer records of passwords are vulnerable to theft including theft via electronic means.

Alternatively, a user may elect to remember the same password for use on a number of systems. Unfortunately, a theft of such a password may lead to unauthorized access to many systems. For example, an unscrupulous web site owner may read a password during a user login and then attempt to use the password at other web sites that the user is likely to access.

In addition, passwords may be stored in unencrypted form in some web sites which makes them attractive targets for hackers. A hacker penetrating a web site could capture passwords as they are decoded to complete the login process. The hacker need not even break into the web site because invocations commonly pass through many machines. Even though a password may be encrypted with SSL over every link between machines, it is often vulnerable to theft within each machine.

A user may rely on a web browser to remember passwords. Unfortunately, this usually hinders login when using a different machine. In addition, passwords held by web browsers may be vulnerable to hackers.

### SUMMARY OF THE INVENTION

A method for generating a password is disclosed that produces a different password for each system from a single password provided by a user. The present techniques enable users to remember one password string from which appropriate system-specific password strings are derived. A system according to the present teachings obtains a user password, generates a combined password by combining the user password with a system name for a system to be accessed, and then generates a system-specific password for the system to be accessed from the combined password using a one-way hash that conforms to a well-defined specification. The hash is selected to ensure that implementations of the present techniques on different systems will produce the same system-specific password for a given combined password.

Other features and advantages of the present invention will be apparent from the detailed description that follows.

### BRIEF DESCRIPTION OF THE DRAWINGS

The present invention is described with respect to particular exemplary embodiments thereof and reference is accordingly made to the drawings in which:

FIG. 1 illustrates the present techniques for providing system-specific passwords;

FIG. 2 shows an example user interface for generating a system-specific password;

FIG. 3 shows a method for generating a system-specific password according to the present techniques.

### DETAILED DESCRIPTION

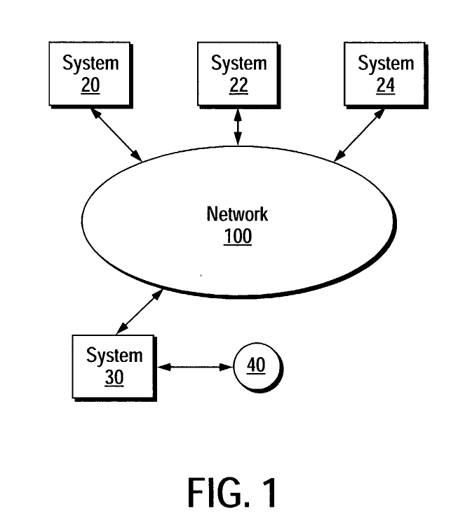

FIG. 1 illustrates the present techniques for providing system-specific passwords. An embodiment is shown which includes a set of systems 20-24 each of which is accessible via a network 100. A user 40 maintains an account on each of the systems 20-24. Each account is accessed using a corresponding system-specific password.

The system-specific passwords for the accounts on the systems 20-24 are generated by a system 30. The system 30 generates the system-specific passwords in response to a user password entered by the user 40 and system names associated with the systems 20-24. For example, the system 30 generates a system-specific password to an account on the system 20 in response to a user password entered by the user 40 and a system name associated with the system 20. Similarly, the system 30 generates a system-specific password to an account on the system 22 in response to the user password and a system name associated with the system 22.

The present techniques enable the user 40 to remember one password string, the user password, and have the system 30 create an appropriate system-specific string from the one password string. These techniques employ a secure one-way hash to provide a system-specific password from one string that the user treats as the password for all of the systems 20-24. The secure one-way hash is selected such that the resulting system-specific passwords are consistent over different implementations of the hash function.

In one embodiment, the systems 20-24 are web sites, the system 30 is a web browser, and the network 100 is a network according to Internet protocols. The present techniques are nevertheless applicable to other types of networks and/or distributed application environments. For example, the network 100 may be a local area network and the systems 20-24, 30 may be computer systems on the local area network and the accounts held by the user 40 may be login accounts on the operating systems executing on the systems 20-24.

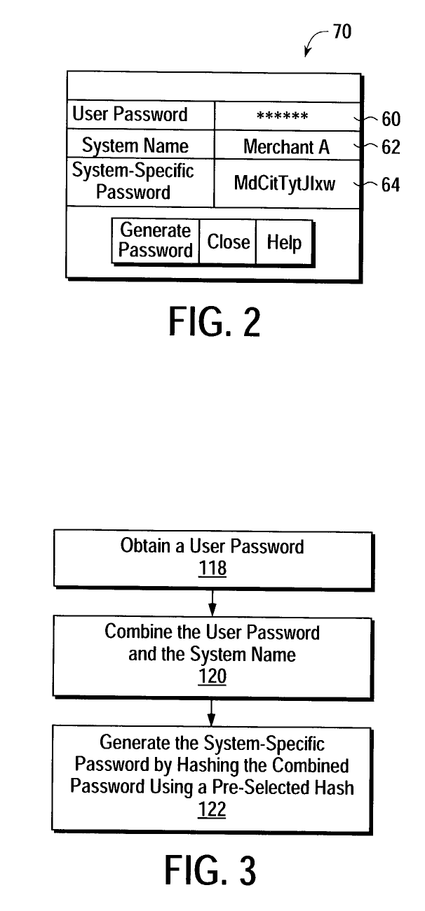

FIG. 2 shows an example user interface 70 for generating a system-specific password. The following focuses on an example in which the system 20 requests a password for a login to an account held by the user 40.

In response to the request for a login password, the system 30 generates the user interface 70 via a user interface mechanism which is available to the user 40. The system 30 obtains a user password 60 and system name 62 for the system 20 from the user 40 via the user interface 70. The user password 60 and the system name 62 may each be an ASCII string.

In one embodiment, code executing on the system 30 generates a system-specific password 64 in response to the user password 60 and the system name 62. The system-specific password 64 is provided to the system 20 via the network 100 during the login to the system 20.

The system name 62 may be an easily remembered name for the system 20. For example, the system name 62 may be a well-know name associated with the system 20 such as a commercial name which may be the subject of a trademark or a name which is generally associated with a service of the system 20.

FIG. 3 shows a method for generating the system-specific password 64 according to the present techniques. The method steps shown are performed by the system 30 in response to the user password 60 and the system name 62 provided by the user 40. At step 118, a user password is obtained from the user 40.

At step 120, the user password 60 is combined with the system name 62. Step 120 is performed in one embodiment by concatenating the user password 60 and the system name 62. Other methods of combining the user password 60 and the system name 62 may be employed in other embodiments.

At step 122, the system-specific password 64 is generated by hashing the combined password from step 120 such that a relationship between the system-specific password 62 and the combined password conforms to a well defined specification. The well-defined specification is selected to ensure that different implementations of the hash will produce the same output string for the system-specific password 62 in response to a given input string for the combined password from step 120.

In one embodiment, the combined password from step 120 is hashed according to the specification provided in Rivest, R., “The MD5 Message-Digest Algorithm,” MIT Laboratory for Computer Science, April 1992. An implementation of the MD5 standard produces a message hash that enables verification of whether or not a message has been altered. The hash of the combined password produced by the MD5 hash yields a binary output of 16 bytes which is converted to ASCII format using Base64 encoding in binary, thereby yielding the system-specific password 64.

An alternative one-way function hash that may be employed at step 122 is SHA-1.

In one embodiment, a sub-portion of the system-specific password 64 yielded by step 122 is discarded in order to hinder guessing attacks for the user password. For example, the leading 12 characters of the system-specific password 64 yielded by step 122 may be used with the remainder discarded.

The system-specific password 64 may include some characters which are not alphanumeric. Given that some login systems do not accept non-alphanumeric characters, the user 40 may skip the non-alphanumeric characters when entering the system-specific password 64 into a login interface to the system 30. Enough alphanumeric characters should be available to provide a high-quality password.

With the present techniques, the user 40 need remember a single password, the user password 60 and an easily remembered system name for each system requiring a login. The system 30 combines these two elements to produce a system-specific password. A system-specific password is valid only on the one system, even though the string typed into the user password field by the user 40 is the same for all systems.

The hashing at step 122 which conforms to a well-defined specification such as MD5 has a number of advantages over hashing schemes that vary with different implementations. For example, the hash at step 122 cannot be inverted to discover the user password 60 even if the system name 62 is known. In addition, a change in one bit in the combined password from step 120 produces a completely different string for the system-specific password 64. Any implementation of MD5 must produce the same output for a given input. Moreover, it is highly unlikely that two different combined passwords will produce the same system-specific password.

Code that implements the present methods may be provided in a browser plug-in that pops up whenever a password field appears in a web page. The system-specific password 64 may be written directly into the input area of the web page. Alternatively, code that implements the present methods may be used as a stand-alone application to generate system-specific passwords that can be typed manually into the password field of a web site. In either case, the code may be distributed via a variety of mechanisms including computer-readable storage media and on-line distribution.

In some environments, there may be fields associated with a password in a web form. A password field may be denoted as an input field of type “password” and a system name understood by the program reading the password. Common examples of this system name are “PASSWORD” and “SignonPassword”. One implementation of the present techniques uses this system name as the system name which is combined with the user password at step 120. Such an embodiment produces a different password for each system, but the user only has to remember a single user password. To prevent an unscrupulous web site from using the system name of another web site, the system name may be made visible to the user—for example via the user interface 70.

Alternatively, a digital signature of a web site as it appears in an SSL certificate may be used as the system name. If the system name does not correspond to the SSL certificate, the user's browser will present a warning.

In another alternative, the user provides the system name to be hashed with the password. This approach has the disadvantage that the user must remember the string, but there is no problem if these strings are memorable.

In yet another alternative, the system 30, for example a web browser, provides the system name. To avoid having browsers on different machines picking different strings, standard system names, such as the URL, may be used.

In another alternative, a URL for a system to be accessed is linked to a file on the system 30 and that file holds a user selected name to be used as the system name. The user 40 sets a system name in that file for each URL of systems to be accessed.

In some embodiments, the system-specific password may be computed using a device such as a smart card or PDA owned by the user 40 that stores the system-specific strings.

The foregoing detailed description of the present invention is provided for the purposes of illustration and is not intended to be exhaustive or to limit the invention to the precise embodiment disclosed. Accordingly, the scope of the present invention is defined by the appended claims.

What is claimed is:

1. A method for generating a system-specific password for a system, comprising the steps of:
obtaining a user password;
generating a combined password by combining the user password with a system name for the system;
generating the system-specific password from the combined password using a one-way hash that conforms to a well-defined specification.

2. The method of claim 1, wherein the step of combining comprises the step of concatenating the user password and the system name.

3. The method of claim 1, wherein the step of generating the system-specific password comprises the steps of:
hashing the combined password using the one-way hash;
converting a binary result of the one-way hash to a character string.

4. The method of claim 3, further comprising the step of discarding a sub-portion of the system-specific password.

5. The method of claim 3, further comprising the step of discarding a set of non-alphanumeric characters in the system-specific password.

6. The method of claim 1, further comprising the step of determining the system name.

7. The method of claim 6, wherein the step of determining the system name comprises the step of determining a commercial name associated with the system.

8. The method of claim 6, wherein the step of determining the system name comprises the step of determining the system name in response to a field associated with a password in a web form.

9. The method of claim 8, further comprising the step of displaying the system name to a user.

10. The method of claim 6, wherein the step of determining the system name comprises the step of determining a digital signature associated with the system.

11. The method of claim 6, wherein the step of determining the system name comprises the step of determining a URL associated with the system.

12. The method of claim 1, wherein the system is a web site.

13. A computer-readable storage media that contains a program that when executed by a computer generates a system-specific password for a system by performing the steps of:
obtaining a user password;
generating a combined password by combining the user password with a system name for the system;
generating the system-specific password from the combined password using a one-way hash that conforms to a well-defined specification.

14. The computer-readable storage media of claim 13, wherein the step of generating the system-specific password comprises the steps of:
hashing the combined password using the one-way hash;
converting a binary result of the one-way hash to a character string.

15. An apparatus for generating a system-specific password for a system, comprising:
means for obtaining a user password;
means for generating a combined password by combining the user password with a system name for the system;
means for generating the system-specific password from the combined password using a one-way hash that conforms to a well-defined specification.

16. The apparatus of claim 15, wherein the means for generating the system-specific password comprises:
means for hashing the combined password using the one-way hash;
means for converting a binary result of the one-way hash to a character string.

17. The apparatus of claim 15, further comprising means for determining the system name in response to a field associated with a password in a web form.

18. The apparatus of claim 15, further comprising means for determining the system name in response to a digital signature associated with the system.

19. The apparatus of claim 15, further comprising means for determining the system name in response to a URL associated with the system.

20. The apparatus of claim 15, further comprising means for displaying the system name to a user.

21. The apparatus of claim 15, wherein the system is a web site.
